(19) United States
(12) Patent Application Publication
(10) Pub. No.: US 2026/0295540 A1
(43) Pub. Date: Oct. 1, 2026

(54) HOLLOW FIBER MEMBRANES COMPRISING A POLY(ARYL ETHER SULFONE) AND A WATER-SOLUBLE POLYMER ADDITIVE

(71) Applicant: BASF SE, Ludwigshafen am Rhein (DE)

(72) Inventors: Oliver GRONWALD, Ludwigshafen am Rhein (DE); Erik GUBBELS, Ludwigshafen am Rhein (DE)

(21) Appl. No.: 19/476,940

(22) PCT Filed: Apr. 15, 2024
(86) PCT No.: PCT/EP2024/060121

§ 371 Date: Oct. 20, 2025

(30) Foreign Application Priority Data
Apr. 21, 2023 (EP) 23169205.4

(51) Int. Cl. B01D 69/08; B01D 53/22; B01D 69/10; B01D 71/44; B01D 71/68; H01M 8/04119

(52) U.S. Cl. CPC B01D 69/08; B01D 53/228; B01D 69/10; B01D 71/441; B01D 71/68; H01M 8/04149; B01D 2053/224; B01D 2257/102

(57) ABSTRACT

Provided is a hollow fiber membrane module that, even when being employed in a case body made of a resin, can prevent the case body from being deformed. A hollow fiber membrane module 10 comprises: a plurality of hollow fiber membranes 200; a case 100 that houses the plurality of hollow fiber membranes 200 and that has a case body 110 made of a resin and having openings at opposing ends; a pair of sealing-fixing parts 310, 320 for, at the opposing ends of the case 100, sealing gaps between the hollow fiber membranes in a state where the hollow insides of the hollow fiber membranes 200 are kept open, and fixing the plurality of hollow fiber membranes 200 to the case 100. The hollow fiber membrane module 10 is characterized in that in the case body 110, a reinforcement part 115 that links together a pair of opposite wall surfaces of inner wall surfaces housing the plurality of hollow fiber membranes 200 is integrally provided on the pair of wall surfaces.

The present invention relates to a hollow fiber membrane made from blends of poly(aryl ether sulfone) and a water-soluble polymer additive, manufacturing methods therefor and their uses. Furthermore, the present invention relates to a separation element, membrane module, separation system, membrane cartridge and fuel cell membrane humidifier containing such membrane or membranes.

In a hydrogen fuel cell, electricity is generated from the reaction of hydrogen and oxygen thereby forming water. In particular, polymer electrolyte membrane (PEM) fuel cells (FC) are used for carbon dioxide emission free transportation applications, wherein ambient air serves as source of oxygen necessary for the fuel cell reaction. For efficient operation and performance of the fuel cell, PEM membranes require a constant humidification at a predetermined level. Therefore, gas-to-gas humidifiers are used to transfer water vapor from the cathode exhaust gases to the intake gas. To provide for humidification, for example lightweight and miniaturized membrane humidifiers are used, wherein the humidifier may contain a hollow fiber membrane and selectively provides water vapor to the fuel cell membrane.

Various materials are being used for hollow fiber membranes. Examples are perfluorinated sulfonic acid polymers (PFSA) (e.g. Nafion®, DuPont), polyimides or polyarylsulfones such as polyethersulfone (PESU) or polysulfone (PSU). US2021154624 A1 is directed to a composite hollow fiber membrane including a hollow fiber membrane and a pollutant entrapping layer coated on the inner surface of the hollow fiber membrane, wherein the membrane can be used in a membrane humidifier for a fuel cell. From environmental standpoints, halogen-containing polymeric membrane material is unfavorable.

For the manufacturing process of polyarylsulfone-based hollow fibers by non-solvent induced phase separation (NIPS) processing, hydrophilic water-soluble polymers such as polyvinylpyrrolidone (PVP) are used as additives to adjust the viscosity of the polymer solution. Such additives may also act as place holders for pores in the filtration layer of the hollow fiber membranes (e.g. S. Munari, Desalination 1988, 70, 265-275). In a subsequent post treatment step the filtration layer is formed by removal of the hydrophilic polymer from the polyarylsulfone matrix. It can selectively be removed by chemical treatment with hypochlorite (I. M. Wienk et. al, Journal Polymer Science: Part A: Polymer Chemistry 1995, 33, 49-54).

With the increasing demand for environmentally friendly provision of electricity, there is need for optimized fuel cell assemblies including membrane humidifiers for efficient and long-lasting operation of the fuel cell.

Consequently, an object of the invention was finding a suitable membrane for fuel cell humidifiers that can selectively withhold gas and transmit water vapor to the fuel cell membrane. A further object was the provision of a selective and halogen-free free membrane with high water vapor transmission useful in fuel cell membrane humidifiers.

This object is achieved with the use of a hollow fiber membrane comprising a porous supporting structure, an inner membrane surface layer (SLᵢₙ) and an outer membrane surface layer (SLₒᵤₜ), the membrane comprising at least one polymer (P) selected from a poly(arylene ether sulfone) and a sulfonated poly(arylene ether sulfone), and a water-soluble polymer additive (A) comprising polyvinylpyrrolidone (PVP), in a fuel cell membrane humidifier and the use of such membrane for selectively withholding nitrogen gas and selectively letting through water vapor from a gaseous mixture comprising water vapor and nitrogen.

Furthermore, within the framework of the present invention, it has been surprisingly found that the inventive hollow fiber membrane comprising a porous supporting structure, an inner membrane surface layer (SLᵢₙ) and an outer membrane surface layer (SLₒᵤₜ), the membrane comprising at least one polymer (P) selected from a poly(arylene ether sulfone) and a sulfonated poly(arylene ether sulfone) and a water-soluble polymer additive (A) comprising at least 10% by weight, based on the total weight of the membrane, polyvinylpyrrolidone (PVP) having a solution viscosity characterized by a K-value of at least 80, exhibits high water transfer rates while selectively withholding undesired gas contained in the gaseous exhaust composition supplied to the fuel cell. The inventive membranes and assemblies containing the inventive membranes are particularly useful for humidifiers in polymer electrolyte membrane fuel cells.

In the context of the present invention, the term “membrane” means a semipermeable structure acting as a selective barrier, allowing some particles, substances or chemicals to pass through, while retaining others. In general, membranes are applied in various liquid and gaseous separations.

The membrane of the present invention is a hollow fiber membrane, wherein it may be a single bore hollow fiber or multiple bore hollow fiber membrane. In a hollow fiber membrane, a semipermeable barrier is in the form of a hollow fiber.

Multiple channel membranes, also referred to as multi bore membranes, comprise more than one longitudinal channel, also referred to as “channel” or “bore”.

The number of channels is typically 2 to 19. In one embodiment, the multiple bore hollow fiber membrane comprises two or three channels. In another embodiment, the multiple bore hollow fiber membrane comprises 5 to 9 channels. In one specific embodiment, the multiple bore hollow fiber membrane comprises seven channels. In yet another embodiment, the multiple bore hollow fiber membrane comprises 20 to 100 channels.

The shape of the bore or bores may vary. Normally, the membranes according to the invention have an essentially circular, ellipsoid or rectangular diameter. Preferably, membranes according to the invention are essentially circular, i.e. the bores have an essentially circular diameter.

In another embodiment, such bores have an essentially ellipsoid diameter. In yet another embodiment, channels have an essentially rectangular diameter. In some cases, the actual form of such channels may deviate from the idealized circular, ellipsoid or rectangular form.

The hollow fiber membrane channels have an inner and an outer diameter. The difference of the outer diameter and the inner diameter is the thickness of the hollow fiber membrane.

Normally, such channels have an outer diameter (for essentially circular diameters), an outer smaller diameter (for essentially ellipsoid diameters) or an outer smaller feed size (for essentially rectangular diameters) of 0.05 mm to 3 mm, preferably 0.5 to 2 mm, more preferably 0.9 to 1.5 mm. In another preferred embodiment, such channels have an outer diameter (for essentially circular diameters), an outer smaller diameter (for essentially ellipsoid diameters) or an outer smaller feed size (for essentially rectangular diameters) in the range from 0.2 to 0.9 mm.

In one preferred embodiment, hollow fiber membranes according to the invention or used according to the invention have an outer diameter (for essentially circular diameters), an outer smaller diameter (for essentially ellipsoid diameters) or an outer smaller feed size (for essentially rectangular diameters) of 2 to 10 mm, preferably 3 to 8 mm, more preferably 4 to 6 mm.

In another preferred embodiment, hollow fiber membranes according to the invention or used according to the invention have an outer diameter (for essentially circular diameters), an outer smaller diameter (for essentially ellipsoid diameters) or an outer smaller feed size (for essentially rectangular diameters) of 2 to 4 mm.

The hollow fiber membrane can have any thickness. For example, the thickness of the membrane is in the range from 20 to 150 μm, preferably in the range from 20 to 100 μm and most preferably in the range from 30 to 60 μm.

If multi-bore hollow fiber membranes contain channels with an essentially rectangular shape, these channels can be arranged in a row. If the channels in a multi-bore hollow fiber membrane have essentially circular shape, these channels are preferably arranged such that a central channel is surrounded by the other channels. In one preferred embodiment, a membrane comprises one central channel and for example four, six or 18 further channels arranged cyclically around the central channel. The wall thickness in such multiple channel membranes is normally from 0.02 to 1 mm at the thinnest position, preferably 30 to 500 μm, more preferably 100 to 300 μm.

The inventive hollow fiber membrane and the hollow fiber membrane used according to the invention, respectively, comprises at least one polymer (P) selected from a sulfonated poly(arylene ether sulfone) and a poly(arylene ether sulfone). The poly(arylene ether sulfone) is non-sulfonated if it is not explicitly mentioned.

Poly(arylene ether sulfone) polymers belong to the group of high temperature resistant polymers showing high heat resistance, excellent mechanical performance and inherent flame retardancy (E. M. Koch, H.-M. Walter, Kunststoffe 80 (1990) 1146; E. Döring, Kunststoffe 80, (1990) 1149, N. Inchaurondo-Nehm, Kunststoffe 2008 190). Polyarylene (ether) sulfones are generally known to a person skilled in the art.

“Non-sulfonated” within the context of the present invention means that the poly(arylene ether sulfone) polymer does not comprise any —SO₂X group, wherein X is selected from the group consisting of Cl⁻ and O⁻ combined with one cation equivalent. “One cation equivalent” within the context of the present invention means one cation of a single positive charge or one charge equivalent of a cation with two or more positive charges, for example, H⁺, Li⁺, Na⁺, K⁺, Mg²⁺, Ca²⁺ or NH₄⁺.

The term “a sulfonated poly(arylene ether sulfone)” or “a poly(arylene ether sulfone)”, respectively, in the present application is understood to mean exactly one sulfonated poly(arylene ether sulfone) polymer or poly(arylene ether sulfone) polymer, respectively, and also mixtures of two or more sulfonated poly(arylene ether sulfone) polymers or of two or more poly(arylene ether sulfone) polymers, respectively.

According to one embodiment, the hollow fiber membrane of the invention or the hollow fiber membrane used according to the invention, respectively, comprises a poly(arylene ether sulfone) polymer (P) as defined or preferably defined herein. In one specific embodiment thereof, the hollow fiber membrane does not contain any sulfonated poly(arylene ether sulfone).

According to these embodiments, the hollow fiber membrane comprises preferably at least 50% by weight of the poly(arylene ether sulfone) polymer (P), more preferably at least 60% by weight and most preferably at least 70% by weight of the poly(arylene ether sulfone) polymer (P) based on the total weight of the hollow fiber membrane.

According to a further embodiment, the hollow fiber membrane of the invention or the hollow fiber membrane used according to the invention, respectively, comprises a sulfonated poly(arylene ether sulfone) polymer (P) as defined or preferably defined herein. In a specific embodiment thereof, the hollow fiber membrane does not contain any (non-sulfonated) poly(arylene ether sulfone).

According to these embodiments, the hollow fiber membrane comprises preferably at least 50% by weight of the sulfonated poly(arylene ether sulfone) polymer (P), more preferably at least 60% by weight and most preferably at least 70% by weight of the sulfonated poly(arylene ether sulfone) polymer (P) based on the total weight of the hollow fiber membrane.

According to still a further embodiment, the hollow fiber membrane of the invention or the hollow fiber membrane used according to the invention, respectively, comprises a sulfonated poly(arylene ether sulfone) as defined or preferably defined herein and a poly(arylene ether sulfone) as defined or preferably defined herein.

If both, the sulfonated and non-sulfonated poly(arylene ether sulfone) is contained in the hollow fiber membrane, the hollow fiber membrane preferably comprises from 5 to 90% by weight, more preferably from 7.5 to 80% by weight, of the sulfonated poly(arylene ether sulfone) polymer (P), based on the total weight of the membrane. The membrane also preferably comprises from 10 to 95% by weight, more preferably from 20 to 92.5% by weight, of the poly(arylene ether sulfone) polymer (P), based on the total weight of the membrane.

Therefore, in a preferred embodiment, the hollow fiber membrane comprises from 5 to 90% by weight of the sulfonated poly(arylene ether sulfone) polymer and from 10 to 95% by weight of the poly(arylene ether sulfone) polymer, based in each case on the total weight of the membrane.

In a preferred embodiment, the sulfonated poly(arylene ether sulfone) polymer comprises units of formula (I)

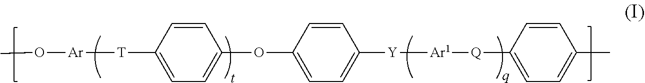

wherein the definitions of the symbols t, q, Q, T, Y, Ar and Ar¹ are as follows:
t, q independently of one another 0, 1, 2 or 3;
Q, T, Y independently of one another a chemical bond or a group selected from —O—, —S—, —SO₂—, S═O, C═O, —N═N— and —CR^{a}R^{b}—, wherein R^{a} and R^{b} independently of one another are a hydrogen atom, (C₁-C₁₂)alkyl, (C₁-C₁₂)alkoxy, (C₃-C₁₂)cycloalkyl or a (C₆-C₁₈)aryl group, and wherein at least one of Q, T, and Y is present and is —SO₂—; and
Ar and Ar¹ independently of one another (C₆-C₁₈)arylene;
and where
at least one unit (I) comprises an arylene group which is substituted with at least one —SO₂X group, wherein X is selected from the group consisting of Cl⁻ and O⁻ combined with one cation equivalent, where the cation equivalent is H⁺, Li⁺, Na⁺, K⁺, Mg²⁺, Ca²⁺ or NH₄⁺.

If Q, T or Y, among the abovementioned conditions, is a chemical bond, this is understood to mean that the adjacent group to the left and the adjacent group to the right are bonded directly to one another via a chemical bond. It will be readily appreciated that at least one of the groups consisting of Q, T and Y being —SO₂— means that at least one group in formula (I) is —SO₂—. Thus, when q is =0, at least one of T and Y is —SO₂—; when, for example, t is =0, at least one of Q and Y is —SO₂— and when q=0 and t=0 then Y is SO₂.

According to one preferred embodiment, t and q are independently 0 or 1.

According to one preferred embodiment, Q, T, and Y in formula II are independently selected from a chemical bond, —O—, —SO₂— and —CR^{a}R^{b}—, with the proviso that at least one of Q, T, and Y is present and is —SO₂—. Furthermore, it may be preferred, if R^{a} and R^{b} are, independently of one another, hydrogen or (C₁-C₄)alkyl.

In —CR^{a}R^{b}—, R^{a} and R^{b} are preferably independently selected from hydrogen, (C₁-C₁₂)alkyl, (C₁-C₁₂)alkoxy and (C₆-C₁₈)aryl.

(C₁-C₁₂)alkyl refers to linear or branched saturated hydrocarbon groups having from 1 to 12 carbon atoms. The following moieties are particularly encompassed: (C₁-C₆)alkyl, e.g. methyl, ethyl, n-propyl, isopropyl, n-butyl, sec-butyl, 2- or 3-methylpentyl, as well as (C₇-C₁₂)alkyl, e.g. unbranched heptyl, octyl, nonyl, decyl, undecyl, lauryl, and the singly branched or multibranched analogs thereof.

The term “C₁-C₁₂-alkoxy” refers to a linear or branched alkyl group having 1 to 12 carbon atoms which is bonded via an oxygen, at any position in the alkyl group, e.g. methoxy, ethoxy, n-propoxy, 1-methylethoxy, butoxy, 1-methyl-propoxy, 2-methylpropoxy or 1,1-dimethylethoxy.

(C₃-C₁₂)cycloalkyl refers to monocyclic saturated hydrocarbon radicals having 3 to 12 carbon ring members and particularly comprises (C₃-C₈)cycloalkyl, e.g. cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohexylmethyl, -dimethyl, and -trimethyl.

Ar and Ar¹ are independently of one another a (C₆-C₁₈)-arylene group. It may be preferred that, according to a specific embodiment, Ar¹ is an unsubstituted (C₆-C₁₂)arylene group.

It may be preferred that Ar and Ar¹ are independently selected from phenylene, bisphenylene and naphthylene groups, and from arylene groups that derive from anthracene, from phenanthrene, or from naphthacene. For examples, Ar and Ar¹ are independently selected from 1,2-phenylene, 1,3-phenylene, 1,4-phenylene, 1,6-naphthylene, 1,7-naphthylene, 2,6-naphthylene and 2,7-naphthylene, 2,7-dihydroxynaphthylene and 4,4′-bisphenylene.

In particular, it may be preferred that Ar and Ar¹ are independently selected from phenylene and naphthylene groups, such as independently selected from 1,2-phenylene, 1,3-phenylene, 1,4-phenylene, 1,6-naphthylene, 1,7-naphthylene, 2,6-naphthylene and 2,7-naphthylene, more specifically independently selected from 1,4-phenylene, 1,3-phenylene and naphthylene. Furthermore, according to another embodiment of the present invention Ar and Ar¹ are independently selected from arylene groups that derive from anthracene, from phenanthrene, or from naphthacene. According to still a further embodiment, Ar and Ar¹ are independently selected from 2,7-dihydroxynaphthylene and 4,4′-bisphenylene.

Preferred sulfonated poly(arylene ether sulfone) polymers are those comprising at least one of the following units Ia to Io as repeat structural units, wherein at least one unit (I) comprises an arylene group which is substituted with at least one —SO₂X group, wherein X is selected from the group consisting of Cl⁻ and O⁻ combined with one cation equivalent, where the cation equivalent is H⁺, Li⁺, Na⁺, K⁺, Mg²⁺, Ca²⁺ or NH₄⁺:

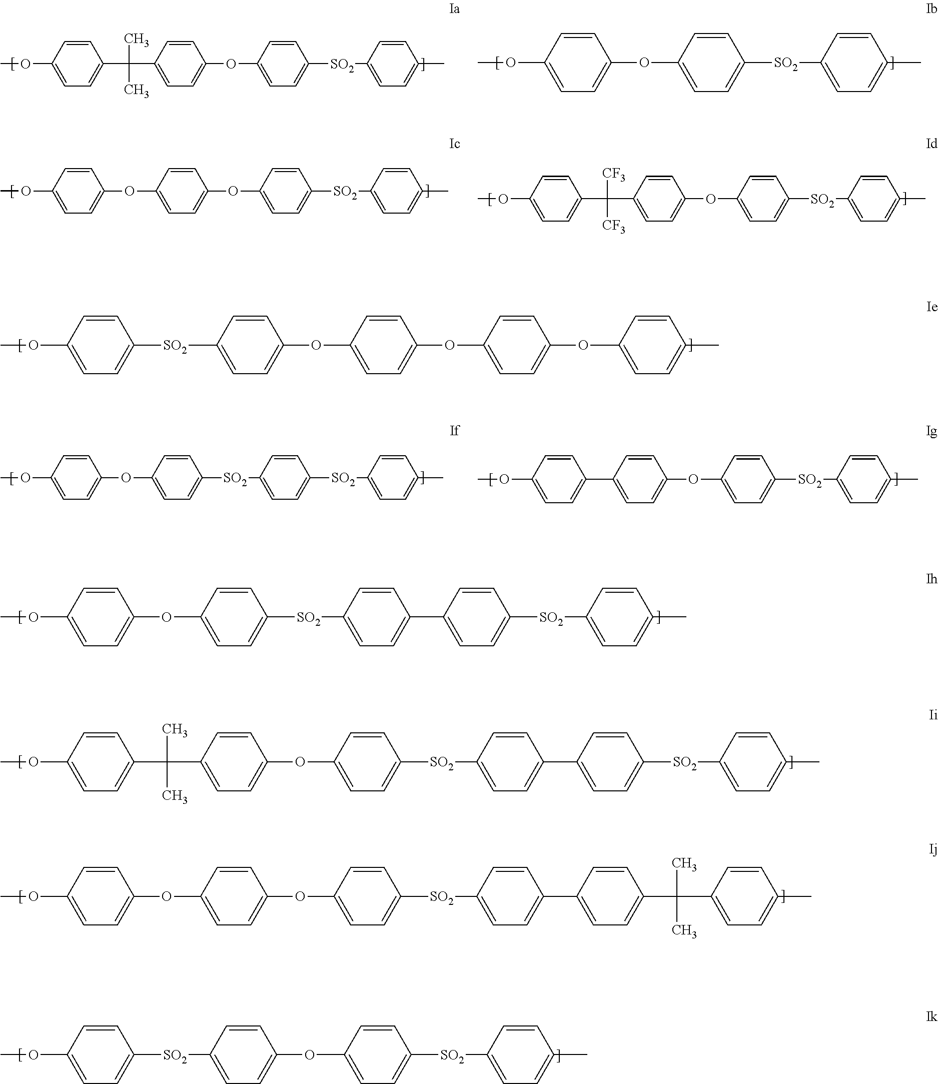

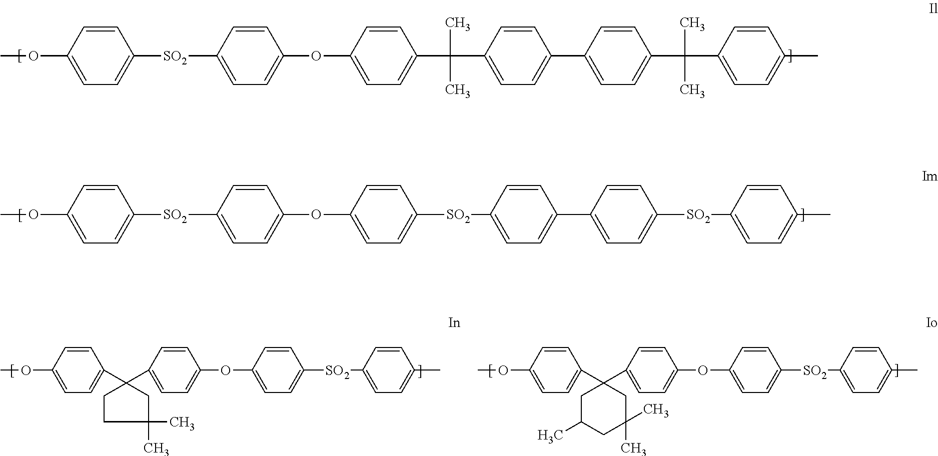

In addition to the preferred units Ia to Io, preference is also given to those units in which one or more 1,4-phenylene units which originate from hydroquinone are replaced by 1,3-phenylene units which originate from resorcinol or by naphthylene units which originate from dihydroxynaphthalene.

Particularly preferred units of the general formula (I) are the units Ia, Ig and Ik. It is also particularly preferred when the sulfonated poly(arylene ether sulfone) polymers are formed essentially from one kind of units of the general formula (I), especially from a unit selected from Ia, Ig and Ik.

In a particularly preferred embodiment, Ar=1,4-phenylene, t=1, q=0, T is a chemical bond and Y═SO₂. Particularly preferred sulfonated poly(arylene ether sulfone) polymers (A) formed from the aforementioned repeat unit are referred to as sulfonated polyphenylene sulfone (PPSU) (formula Ig).

In a further particularly preferred embodiment, Ar=1,4-phenylene, t=1, q=0, T=C(CH₃)₂ and Y═SO₂. Particularly preferred sulfonated poly(arylene ether sulfone) polymers (A) formed from the aforementioned repeat unit are referred to as sulfonated polysulfone (PSU) (formula Ia).

In a further particularly preferred embodiment, Ar=1,4-phenylene, t=1, q=0, T=Y═SO₂. Particularly preferred sulfonated poly(arylene ether sulfone) polymers (A) formed from the aforementioned repeat unit are referred to as sulfonated poly(ether sulfone) (PESU) (formula Ik).

Abbreviations such as PPSU, PESU and PSU in the context of the present invention conform to DIN EN ISO 1043-1 (Plastics-Symbols and abbreviated terms-Part 1: Basic polymers and their special characteristics (ISO 1043-1:2001); German version EN ISO 1043-1:2002).

In a preferred embodiment, the sulfonated poly(arylene ether sulfone) polymer is a copolymer formed from poly(ether sulfone) (PESU) units and poly(phenylene sulfone) (PPSU) units, wherein at least one unit comprises an arylene group which is substituted with at least one —SO₂X group, wherein X is selected from the group consisting of Cl⁻ and O⁻ combined with one cation equivalent, where the cation equivalent is H⁺, Li⁺, Na⁺, K⁺, Mg²⁺, Ca²⁺ or NH₄⁺. This copolymer may, for example, be a random copolymer or a block copolymer. Preference is given to a random copolymer formed from poly(ether sulfone) (PESU) and poly(phenylene sulfone) (PPSU) for the reason that a more homogenous material is obtained which shows no or little phase separation in the dissolved or solid state.

In case the sulfonated poly(arylene ether sulfone) polymer is a copolymer formed from poly(ether sulfone) (PESU) units and poly(phenylene sulfone) (PPSU) units, the sulfonated poly(arylene ether sulfone) polymer comprises in the range from 1 to 20 mol % of poly(phenylene sulfone) (PPSU) units and from 80 to 99 mol % of poly(ether sulfone) (PESU) units, in each case based on the total sum of all repeating units.

In a particularly preferred embodiment, the sulfonated poly(arylene ether sulfone) polymer comprises units of formula (III)

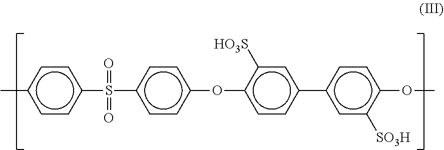

and/or formula (IV)

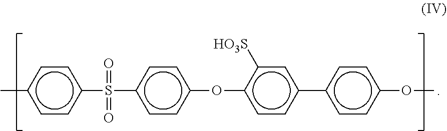

In a further particularly preferred embodiment, the sulfonated poly(arylene ether sulfone) polymer comprises units of formula (V)

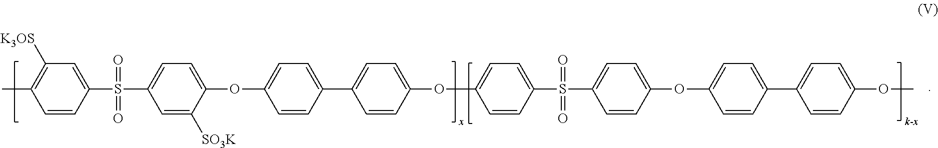

It is also possible that the sulfonated poly(arylene ether sulfone) polymer comprises units of formula (III) and/or formula (IV) and/or formula (V).

The sulfonated poly(arylene ether sulfone) polymer preferably has a number-average molecular weight (M_{N}) of from 10000 to 35000 g/mol, determined by gel permeation chromatography in dimethylacetamide as solvent versus narrowly distributed polymethyl methacrylate as standard.

In addition, the sulfonated poly(arylene ether sulfone) polymer preferably has a content of free acid of less than 3 mg KOH/g sulfonated poly(arylene ether sulfone) polymer, determined by titration with 0.1 mol/l tetrabutylammoniumhydroxide solution (TBAH, in methanol/toluene) against a Solvotrode electrode (Metrohm).

The sulfonated poly(arylene ether sulfone) polymer can be prepared by any method known to the person skilled in the art.

Preferably, the sulfonated poly(arylene ether sulfone) polymer is produced by treating a respective non-sulfonated poly(arylene ether sulfone) polymer with at least one sulfonating agent. The at least one sulfonating agent is suitably any compound known to a person skilled in the art that is capable of introducing at least one SO₂X group, where X is Cl⁻ or O⁻, combined with one cation equivalent, where the cation equivalent is H⁺, Li⁺, Na⁺, K⁺, Mg²⁺, Ca²⁺ or NH₄⁺, into an aromatic ring of the non-sulfonated poly(arylene ether sulfone) polymer. The SO₂X group is preferably a sulfonic acid group (—SO₃H) or a group capable of reacting with water to form a sulfonic acid group. Groups of this type are known to a person skilled in the art and include, for example, chlorosulfonyl groups (—SO₂Cl). The SO₂X group is more preferably therefore a sulfonic acid group (—SO₃H) or a chlorosulfonyl group (—SO₂Cl), most preferably the SO₂X group is a sulfonic acid group (—SO₃H).

The reaction of the non-sulfonated poly(arylene ether sulfone) polymer with the at least one sulfonating agent preferably sulfonates at least one of the aromatic rings of the non-sulfonated poly(arylene ether sulfone) polymer at least partially.

The mechanism of the sulfonation reaction is known as such to a person skilled in the art. Thereby it is particularly preferable for the sulfonation reaction to replace a hydrogen atom of the aromatic ring by a sulfonic acid group (—SO₃H).

Typically, from 0.001 to 1, preferably from 0.005 to 0.1 and more preferably from 0.01 to 0.08 SO₂X groups per aromatic ring is introduced into the non-sulfonated poly(arylene ether sulfone) polymer. The sulfonated poly(arylene ether sulfone) polymer therefore typically has from 0.001 to 1, preferably from 0.005 to 0.1, and more preferably from 0.01 to 0.08 sulfonic acid groups per aromatic ring.

The number of SO₂X groups per aromatic ring is determined by averaging over all the aromatic rings of the sulfonated poly(arylene ether sulfone) polymer. To this end, the number of SO₂X groups in the sulfonated poly(arylene ether sulfone) polymer is divided by the number of aromatic rings in the sulfonated poly(arylene ether sulfone) polymer. Methods of determining the number of SO₂X groups and the number of aromatic rings, each in the sulfonated poly(arylene ether sulfone) polymer, are known to a person skilled in the art. The number of SO₂X groups is determinable, for example, by acid-base titration or by spectroscopic methods such as H¹NMR spectroscopy or IR spectroscopy (infrared spectroscopy). Sulfonated aromatic polymers having SO₂X groups on the aromatic ring display characteristic peaks and bands, making it possible to determine the number of SO₂X groups per aromatic ring in the sulfonated poly(arylene ether sulfone) polymer. The ratio of sulfonated to non-sulfonated aromatic rings can also be determined by these methods, in particular by H¹NMR spectroscopy.

It may be preferred that the (non-sulfonated) poly(arylene ether sulfone) polymer is composed of units of the general formula (I)

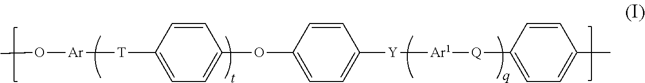

wherein the definitions of the symbols t, q, Q, T, Y, Ar and Ar¹ are as follows:
t, q independently of one another 0, 1, 2 or 3;
Q, T, Y independently of one another a chemical bond or a group selected from —O—, —S—, —SO₂—, S═O, C═O, —N═N— and —CR^{a}R^{b}—, wherein R^{a} and R^{b} independently of one another are a hydrogen atom, (C₁-C₁₂)alkyl, (C₁-C₁₂)alkoxy, (C₃-C₁₂)cycloalkyl or a (C₆-C₁₈)aryl group, and wherein at least one of Q, T, and Y is present and is —SO₂—; and
Ar and Ar¹ independently of one another (C₆-C₁₈)arylene.

If, within the abovementioned preconditions, Q, T or Y is a chemical bond, this means that the adjacent group on the left-hand side and the adjacent group on the right-hand side are present with direct linkage to one another via a chemical bond.

According to one preferred embodiment, t and q are independently 0 or 1.

According to one preferred embodiment, Q, T, and Y in formula II are independently selected from a chemical bond, —O—, —SO₂— and —CR^{a}R^{b}—, with the proviso that at least one of Q, T, and Y is present and is —SO₂—. Furthermore, it may be preferred, if R^{a} and R^{b} are, independently of one another, hydrogen or (C₁-C₄)alkyl.

In —CR^{a}R^{b}—, R^{a} and R^{b} are preferably independently selected from hydrogen, (C₁-C₁₂)alkyl, (C₁-C₁₂)alkoxy and (C₆-C₁₈)aryl.

The terms (C₁-C₁₂)alkyl, “C₁-C₁₂-alkoxy”, (C₃-C₁₂)cycloalkyl, Ar and Ar¹ are defined and preferably defined above.

Poly(arylene ether sulfone) polymers comprising at least one of the units Ia to Io as defined above as repeat structural units may be preferred.

Other repeat units, in addition to the units Ia to Io that may preferably be present, are those in which one or more 1,4-phenylene units deriving from hydroquinone have been replaced by 1,3-phenylene units deriving from resorcinol, or by naphthylene units deriving from dihydroxynaphthalene.

Units of the general formula (I) that are particularly preferred are the units Ia, Ig, and/or Ik. According to a specific embodiment, it is particularly preferred that the poly(arylene ether sulfone) polymer is in essence composed of one type of unit of the general formula (I), whereby said one type may particularly be selected from Ia, Ig, and Ik.

According to a preferred embodiment, the poly(arylene ether sulfone) polymer is composed of repeat units where Ar is 1,4-phenylene, t is 1, q is 0, T is a chemical bond, and Y is SO₂. This poly(arylene ether sulfone) is also termed polyphenylene sulfone (PPSU) (formula Ig).

According to a further preferred embodiment, the poly(arylene ether sulfone) polymer is composed of repeat units where Ar is 1,4-phenylene, t is 1, q is 0, T is C(CH₃)₂, and Y is SO₂. This poly(arylene ether sulfone) is also termed polysulfone (PSU) (formula Ia).

According to still a further preferred embodiment, the poly(arylene ether sulfone) polymer (P) is composed of repeat units where Ar is 1,4-phenylene, t is 1, q is 0, T and Y are SO₂. This poly(arylene ether sulfone) is also termed polyether sulfone (PESU) (formula Ik).

For the purposes of the present disclosure, abbreviations such as PPSU, PESU, and PSU are in accordance with DIN EN ISO 1043-1:2001.

The weight-average molar masses M_{w} of the poly(arylene ether sulfone) polymer (P) are preferably from 10000 to 40000 g/mol, more specifically from 10000 to 37000 g/mol, in particular from 12000 to 35000 g/mol, particularly preferably from 14000 to 33000 g/mol, determined by means of gel permeation chromatography in dimethylacetamide as solvent against narrowly distributed polymethyl methacrylate as standard.

Production processes that lead to the abovementioned poly(arylene ether sulfone) polymers are known per se to the person skilled in the art and are described by way of example in Herman F. Mark, “Encyclopedia of Polymer Science and Technology”, third edition, volume 4, 2003, chapter “Polsulfones” pages 2 to 8, and also in Hans R. Kricheldorf, “Aromatic Polyethers” in: Handbook of Polymer Synthesis, second edition, 2005, pages 427 to 443.

The synthesis of the poly(arylene ether sulfone) polymers can generally be done by polycondensation of appropriate monomers in dipolar-aprotic solvents at elevated temperatures (R. N. Johnson et. al., J. Polym. Sci. A-1 5 (1967) 2375, J. E. McGrath et. al., Polymer 25 (1984) 1827).

The known poly(arylene ether sulfone) polymers usually have halogen end groups, in particular —F or —Cl, or phenolic OH end groups or phenolate end groups, where the latter can be present as such or in reacted form, in particular in the form of —OCH₃ end groups.

Particular preference is given to the reaction, in aprotic polar solvents and in the presence of anhydrous alkali metal carbonate, in particular sodium carbonate, potassium carbonate, calcium carbonate, or a mixture thereof, very particularly preferably potassium carbonate, between at least one aromatic compound having two halogen substituents and at least one aromatic compound having two functional groups reactive toward abovementioned halogen substituents. One particularly suitable combination is N-methyl-2-pyrrolidone as solvent and potassium carbonate as base.

It is preferable that the poly(arylene ether sulfone) polymers have either halogen end groups, in particular chlorine end groups, or etherified end groups, in particular alkyl ether end groups, these being obtainable via reaction of the OH or, respectively, phenolate end groups with suitable etherifying agents. Examples of suitable etherifying agents are monofunctional alkyl or aryl halide, e.g. C₁-C₆-alkyl chloride, C₁-C₆-alkyl bromide, or C₁-C₆-alkyl iodide, preferably methyl chloride, or benzyl chloride, benzyl bromide, or benzyl iodide, or a mixture thereof. For the purposes of the polyarylene (ether) sulfones of component A) preferred end groups are halogen, in particular chlorine, alkoxy, in particular methoxy, aryloxy, in particular phenoxy, or benzyloxy.

According to the present invention, the hollow fiber membrane furthermore comprises a water-soluble polymer additive (A), wherein said additive (A) comprises polyvinylpyrrolidone (PVP).

Polyvinylpyrrolidone is commercially available, e.g. Luvitec® from BASF SE. According to one embodiment, the PVP has a solution viscosity characterized by a K-value of at least 12 (PVP K12), of at least 17 (PVP K17), of at least 30 (PVP K30), of at least 80 (PVP K80), of at least 85 (PVP K85) or of at least 90 (PVP K90). Preferably, the PVP has a solution viscosity characterized by a K-value of at least 80 (PVP K80), such as for example Luvitec® K80. In a further preferred embodiment, the PVP has a solution viscosity characterized by a K-value of at least 85 (PVP K85), such as for example Luvitec® K85. Particularly preferred is PVP having a solution viscosity characterized by a K-value of at least 90 (PVP K90), such as for example Luvitec® K90.

The solution viscosity is determined according to the method of Fikentscher (Fikentscher, Cellulosechemie 13, 1932 (58).

The water-soluble additive (A) may furthermore comprise constituents selected from poly(alkylene oxides) and alcohols. Examples for suitable poly(alkylene oxides) are poly(ethylene oxide), poly(propylene oxide) and poly(ethylene oxide)-poly(propylene oxide) copolymer. Examples for suitable alcohols are divalent alcohols or trivalent alcohols like glycerol.

Preferably, the water-soluble polymer additive (A) comprises at least 50% by weight, preferably at least 60% by weight, in particular at least 70% by weight of PVP in relation to the amount of additive (A) in the membrane.

In a preferred embodiment, the water-soluble polymer additive (A) consists of polyvinylpyrrolidone as defined and preferably herein.

According to a further embodiment, the water-soluble polymer additive (A) consists of PVP, as defined and preferably herein, and at least one alcohol, preferably glycerol. In particular, the water-soluble polymer additive (A) contains 30 to 90% by weight of polyvinylpyrrolidone) and 10 to 70% by weight of at least one alcohol, preferably glycerol.

The amount of PVP, as defined and preferably defined herein, in the hollow fiber membrane is preferably at least 10% by weight based on the total weight of the membrane, more specifically at least 11% by weight, even more specifically at least 12% by weight. In a further embodiment, the amount of PVP in the hollow fiber membrane is at least 13% by weight, more specifically at least 14% by weight, even more specifically at least 15% by weight. In still a further embodiment, the amount of PVP in the hollow fiber membrane is at least 16% by weight. In particular, PVP is present in an amount of 10 to 30% by weight, more specifically 10 to 20% by weight. This content is also called PVPₜₒₜₐₗ

According to one aspect, the present invention relates to the use of a hollow fiber membrane, comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP), in a humidifier, more specifically in a fuel cell membrane humidifier.

According to another aspect, the present invention relates to the use of a hollow fiber membrane, comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP), for selectively withholding nitrogen gas and selectively letting through water vapor from a gaseous mixture comprising water vapor and nitrogen.

In particular, the described hollow fiber membranes are particularly useful for humidifiers in polymer electrolyte membrane fuel cells.

According to still another aspect, the present invention relates to a hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising at least 10 weight %, based on the total weight of the membrane, polyvinylpyrrolidone (PVP) having a solution viscosity characterized by a K-value of at least 80.

In the inventive membrane, PVP is present in an amount of at least 10% by weight based on the total weight of the membrane. This content is also called PVPₜₒₜₐₗ. More specifically, the amount of PVP in the inventive membrane is at least 11% by weight, even more specifically at least 12% by weight. In a further embodiment, the amount of PVP in the membrane is at least 13% by weight, more specifically at least 14% by weight, even more specifically at least 15% by weight. In still a further embodiment, the amount of PVP in the membrane is at least 16% by weight. In particular, PVP is present in an amount of 10 to 30% by weight, more specifically 10 to 20% by weight.

The inventive hollow fiber membrane and the hollow fiber membrane used according to the present invention comprises a porous supporting structure, an inner membrane surface layer (SLᵢₙ) and an outer membrane surface layer (SLₒᵤₜ).

The person skilled in the art knows that the inner membrane surface layer (SLᵢₙ) and/or the outer membrane surface layer (SLₒᵤₜ) serve(s) as the active separation layer(s). The supporting structure typically comprises pores. The minimal pore diameter of the supporting structure of the inventive hollow fiber membrane and the hollow fiber membrane used according to the invention may be <10 nm and the supporting structure can have pore diameters up to 10 μm. Preferably, the content of polyvinylpyrrolidone in the inner or in the outer membrane surface layer is at least 10% by weight, based on the total weight of the membrane. In a further embodiment, the content of polyvinylpyrrolidone in the inner and the outer membrane surface layer is at least 10 weight %, based on the total weight of the membrane.

Preferably, the PVP content in the inner membrane surface layer (SLᵢₙ) is at least 10% by weight, based on the total weight of the membrane. This content is also called PVPᵢₙ. More specifically, PVPᵢₙ is at least 11% by weight, even more specifically at least 12% by weight. In a further embodiment, PVPᵢₙ is at least 13% by weight, more specifically at least 14% by weight, even more specifically at least 15% by weight. In still a further embodiment, PVPᵢₙ is at least 16% by weight. In particular, PVPᵢₙ may be 10 to 30% by weight, more specifically 10 to 20% by weight.

Preferably, the PVP content in the outer membrane surface layer (SLₒᵤₜ) is at least 10% by weight based on the total weight of the membrane. This content is also called PVPₒᵤₜ. More specifically, PVPₒᵤₜ is at least 11% by weight, even more specifically at least 12% by weight. In a further embodiment, PVPₒᵤₜ is at least 13% by weight, more specifically at least 14% by weight, even more specifically at least 15% by weight. In still a further embodiment, PVPₒᵤₜ is at least 16% by weight. In particular, PVPₒᵤₜ may be 10 to 30% by weight, more specifically 10 to 20% by weight.

The inventive hollow fiber membrane is characterized by exhibiting high water transfer rates while selectively withholding gas such as nitrogen. This combination of properties makes the inventive membranes particularly useful for the use in humidifies, in particular in fuel cell membrane humidifiers, where water vapor needs to selectively pass through the membrane. In particular, in fuel cell humidifier assemblies a gaseous exhaust composition is supplied to the fuel cell and undesired gas contained therein, such as, in particular nitrogen, needs to be withheld.

Further gasses that may be contained in the gaseous composition supplied to the fuel cell are, for example, nitrogen, oxygen, carbon dioxide, carbon monoxide, noble gasses and/or ambient air.

According to the invention, the hollow fiber membrane preferably has a water vapor transmission rate of at least 3.5 kg/h·m² at 80° C., more specifically of at least 3.6 kg/h·m² at 80° C., even more specifically of at least 3.7 kg/h·m² at 80° C. at a water flux (WET-IN) of 10 g/s m². In particular, the hollow fiber membrane preferably has a water vapor transmission rate of at least 3.8 kg/h·m² at 80° C., more specifically of at least 3.9 kg/h·m² at 80° C., even more specifically of at least 4.0 kg/h·m² at 80° C. at a water flux (WET-IN) of 10 g/s m².

According to the invention, the hollow fiber membrane preferably has a nitrogen gas permeability of 3 L/m²·h·bar or lower at 2 bar, more specifically of 2.9 L/m²·h·bar or lower at 2 bar, even more specifically of 2.8 L/m²·h·bar or lower at 2 bar, measured before contact with water vapor. In particular, the hollow fiber membrane preferably has a nitrogen gas permeability of 2.7 L/m²·h·bar or lower at 2 bar, more specifically of 2.6 L/m²·h·bar or lower at 2 bar, even more specifically of 2.5 L/m²·h·bar or lower at 2 bar, measured before contact with water vapor. According to a very specific embodiment, the hollow fiber membrane preferably has a nitrogen gas permeability of 2.4 L/m²·h·bar or lower at 2 bar, more specifically of 2.3 L/m²·h·bar or lower at 2 bar, even more specifically of 2.2 L/m²·h·bar or lower at 2 bar, measured before contact with water vapor. According to a further very specific embodiment, the hollow fiber membrane preferably has a nitrogen gas permeability of 2.1 L/m²·h·bar or lower at 2 bar, more specifically of 2.0 L/m²·h·bar or lower at 2 bar, even more specifically of 1.9 L/m²·h·bar or lower at 2 bar, measured before contact with water vapor.

According to the invention, the hollow fiber membrane preferably has a Brunauer-Emmet-Teller (BET) value of the surface (=overall surface of the membrane measured) of 35 m²/g or lower, in particular 34 m²/g or lower, more specifically 33 m²/g or lower. Even more particularly, the hollow fiber membrane preferably has BET value of the surface of 32 m²/g or lower, in particular 31 m²/g or lower, more specifically 30 m²/g or lower. It may be preferred, if the BET value of the surface is 29 m²/g or lower, in particular 28 m²/g or lower. The BET surface is determined by gas-adsorption-desorption (GAD) experiments with nitrogen by 5-point method with ASAP 2420 (Fa. Micromeritics, Norcross, USA). The samples are activated at 130° C. for 15 min before measurement

A further aspect of the present invention is a method for the preparation of the inventive hollow fiber membrane, wherein the process comprises the steps:
a) providing a solution (S) which comprises at least one polymer (P) selected from a sulfonated poly(arylene ether sulfone) and a poly(arylene ether sulfone), a water-soluble polymer additive (A) comprising polyvinylpyrrolidone (PVP) having a solution viscosity characterized by a K-value of at least 80, and at least one solvent (D);
b) passing the solution (S) through a spinneret and contacting the hollow fiber formed with at least one protic polar solvent, thereby forming the hollow fiber membrane; and
c) isolating the hollow fiber membrane without carrying out a step of removal of the additive (A) from the membrane.

In step a), a solution (S) is provided comprising the at least one polymer (P) selected from a sulfonated poly(arylene ether sulfone) and a poly(arylene ether sulfone), as defined and preferably defined herein, a water-soluble polymer additive (A), and at least one solvent (D), wherein the water-soluble polymer additive (A) comprises polyvinylpyrrolidone (PVP) having a solution viscosity characterized by a K-value of at least 80 as defined and preferably defined herein.

The solution (S) in step a) can be provided by any method known to the skilled person. For example, the solution (S) can be provided in step a) in customary vessels that may comprise a stirring device and preferably a temperature control device. Preferably, the solution (S) is provided by dissolving the polymer (P) and the water-soluble polymer additive (A) in the at least one solvent (D).

The dissolution of the polymer (P) and the water-soluble polymer additive (A) in the at least one solvent (D) to provide the solution (S) is preferably effected under agitation.

Step a) is preferably carried out at elevated temperatures, especially in the range from 20 to 100° C., more preferably in the range from 40 to 80° C. A person skilled in the art will choose the temperature in accordance with the at least one solvent (D).

The solution (S) preferably comprises the polymer (P) and the water-soluble polymer additive (A) completely dissolved in the at least one solvent (D). This means that the solution (S) preferably comprises no solid particles of the polymer (P) and the water-soluble polymer additive (A).

The at least one polymer (P) used in the inventive process is selected from a sulfonated poly(arylene ether sulfone) and a poly(arylene ether sulfone) and is defined and preferably defined above.

The solution (S) may comprise from 1 to 50% by weight of the at least one polymer (P) selected from a sulfonated poly(arylene ether sulfone) and a poly(arylene ether sulfone), in particular from 1 to 45% by weight, specifically from 5 to 40% by weight, more specifically from 8 to 35% by weight, based in each case on the total weight of the solution(S).

The water-soluble polymer additive (A) comprising polyvinylpyrrolidone (PVP) having a solution viscosity characterized by a K-value of at least 80 is as defined and preferably defined above.

Preferably, the water-soluble polymer additive (A) comprises at least 50% by weight, preferably at least 60% by weight, in particular at least 70% by weight of PVP in relation to the total weight of additive (A) in the solution (A). In a preferred embodiment, the water-soluble polymer additive (A) consists of polyvinylpyrrolidone as defined and preferably defined above.

Preferably, the solution (S) comprises at least 3% by weight, more specifically at least 4% by weight, even more specifically at least 4.5% by weight of the polyvinylpyrrolidone (PVP) with a solution viscosity characterized by a K-value of at least 80, based in each case on the total weight of the solution(S). In particular, the solution (S) may comprise 3 to 30% by weight, more specifically from 3 to 25% by weight, even more specifically from 3 to 20% by weight of the water-soluble polymer additive (A), based in each case on the total weight of the solution(S). According to a further embodiment, the solution (S) comprises at least 4% by weight, more specifically 4 to 30% by weight, even more specifically 5 to 30% by weight of the polyvinylpyrrolidone (PVP) with a solution viscosity characterized by a K-value of at least 80, based in each case on the total weight of the solution(S).

As described above, the water-soluble polymer additive (A) used in the process of the inventive comprises polyvinylpyrrolidone, but may also additionally comprise other suitable water-soluble additives such as, for example selected from poly(alkylene oxides) and alcohols.

Examples for suitable poly(alkylene oxides) that may be comprised in the water-soluble polymer additive (A) are poly(ethylene oxide), poly(propylene oxide) and poly(ethylene oxide)-poly(propylene oxide) copolymer. Examples for suitable alcohols that may be comprised in the water-soluble polymer additive (A) are divalent alcohols or trivalent alcohols like glycerol.

According to one embodiment, the water-soluble polymer additive (A) comprises 60 to 90% by weight of polyvinylpyrrolidone and from 10 to 40% by weight of at least one alcohol, preferably glycerol.

According to one embodiment, the solution (S) comprises from 1 to 50% by weight of the at least one polymer (P) selected from a sulfonated poly(arylene ether sulfone) and a poly(arylene ether sulfone), from 3 to 30% by weight of the water-soluble polymer additive (A) consisting of PVP as defined and preferably defined herein, and from 20 to 96% by weight of the at least one solvent (D), based in each case on the total weight of the solution(S).

According to a further embodiment, the solution (S) comprises from 1 to 40% by weight of the at least one polymer (P) selected from a sulfonated poly(arylene ether sulfone) and a poly(arylene ether sulfone), from 3 to 20% by weight of the water-soluble polymer additive (A) consisting of PVP as defined and preferably defined herein, and from 40 to 96% by weight of the at least one solvent (D), based in each case on the total weight of the solution(S).

“At least one solvent” within the context of the present invention means precisely one solvent, and also a mixture of two or more solvents. The at least one solvent (D) can be any solvent known to the skilled person that is suitable for the at least one polymer (P) selected from a sulfonated poly(arylene ether sulfone) and a poly(arylene ether sulfone) and the water-soluble polymer additive (A). Preferably, the at least one solvent (D) is soluble in water.

Therefore, the at least one solvent (D) is preferably selected from the group consisting of N-alkyl-2-pyrrolidone, preferably N-methyl-2-pyrrolidone, N-ethyl-2-pyrrolidone, N-butyl-2-pyrrolidone and N-tert.-butyl-2-pyrrolidone, 2-pyrrolidone, N-dimethylacetamide, dimethylsulfoxide, dimethylformamide, N,N-dimethyl-2-hydroxypropan amide, N,N-diethyl-2-hydroxypropan amide, γ-valerolactone, dihydrolevoglucosenone, methyl 5-(dimethylamino)-2-methyl-5-oxopentanoate and sulfolane. N-alkyl-2-pyrrolidone, γ-valerolactone and N, N-dimethyl-2-hydroxypropan amide are particularly preferred. N-methylpyrrolidone is most preferred as the at least one solvent (D).

The solution (S) can comprise, for example, in the range from 20 to 96% by weight of the at least one solvent (D), preferably in the range from 40 to 96% by weight of the at least one solvent (D), more preferably in the range from 50 to 70% by weight of the at least one solvent (D), based on the total weight of the solution(S).

To the person skilled in the art it is clear that the percentages by weight of the at least one polymer (P) selected from a sulfonated poly(arylene ether sulfone) and a poly(arylene ether sulfone), the water-soluble polymer additive (A) and the least one solvent (D). typically add up to 100% by weight.

The duration of step a) may vary between wide limits and is preferably in the range from 10 min to 48 h (hours), especially in the range from 10 min to 24 h, and more preferably in the range from 15 min to 12 h. A person skilled in the art will choose the duration of step a) so as to obtain a homogeneous solution of the at least one polymer (P) selected from a sulfonated poly(arylene ether sulfone) and a poly(arylene ether sulfone) and the water-soluble polymer additive (A) in the at least one solvent (D).

In step b), the solution (S) is passed through a spinneret and the hollow fiber formed is contacted with at least one protic polar solvent, thereby forming the hollow fiber membrane. For producing multi-bore hollow fibers step b) may be performed by extruding the solution (S) through an extrusion nozzle (also called spinneret) with the required number of hollow needles. In particular, the hollow fiber is preferably introduced into a liquid comprising at least one protic polar solvent.

Before carrying out step b), it is possible to filter solution (S) to obtain a filtered solution(S). Moreover, it is possible to degas the solution (S) before step b) is carried out. The degassing of the solution (S) can be carried out by any method known to the skilled person, for example, via vacuum or by allowing the solution (S) to rest.

Preferably, the single bore or multi-bore hollow fiber membrane is obtained by following a phase inversion process, which means that the composition of dissolved at least one polymer (P) selected from a sulfonated poly(arylene ether sulfone) and a poly(arylene ether sulfone) and water-soluble polymer additive (A) are transformed into a solid phase.

Phase inversion processes are in general known to the person skilled in the art.

The phase inversion process can, for example, be performed by cooling down the solution, wherein the at least one polymer (P) selected from a sulfonated poly(arylene ether sulfone) and a poly(arylene ether sulfone) comprised in the solution precipitates. Another possibility to perform the phase inversion process is to bring the solution in contact with a gaseous liquid that is a non-solvent for the at least one polymer (P) selected from a sulfonated poly(arylene ether sulfone) and a poly(arylene ether sulfone). The at least one polymer (P) selected from a sulfonated poly(arylene ether sulfone) and a poly(arylene ether sulfone) will then as well precipitate.

Suitable gaseous liquids that are non-solvents for the at least one polymer (P) selected from a sulfonated poly(arylene ether sulfone) and a poly(arylene ether sulfone) are, for example, protic polar solvents described hereinafter in their gaseous state. Another phase inversion process which is preferred within the context of the present invention is the phase inversion by immersing the solution into at least one protic polar solvent.

Therefore, according to step b) of the inventive process, the hollow fiber formed from the solution(S) is contacted with at least one protic solvent. This leads to the formation of the hollow fiber membrane.

In particular, according to one embodiment of step b), the hollow fiber is contacted with the at least one protic polar solvent by introducing the hollow fiber into a liquid comprising said at least one protic solvent. The liquid may be a bath, such as a coagulation bath.

Suitable at least one protic polar solvents are known to the skilled person. The at least one protic polar solvent is preferably a non-solvent for the at least one polymer (P) selected from a sulfonated poly(arylene ether sulfone) and a poly(arylene ether sulfone). Preferred at least one protic polar solvents are water, methanol, ethanol, n-propanol, iso-propanol, glycerol, ethylene glycol and mixtures thereof.

Preferably, the at least one protic polar solvent is a water-based coagulation liquid. Therefore, another object of the present invention is a method for the preparation of a hollow fiber membrane, wherein the at least one protic polar solvent in step c) is a water-based coagulation liquid.

The water-based coagulation liquid may comprise further components besides water, such as, for example, the same solvent (D) as comprised in the solution (S) or an alcohol, such as, for example, glycerol.

The at least one polar solvent used as coagulating liquid may also be injected through the hollow needles into the extruded polymer solution (S) during the step of passing the solution through the spinneret. Thereby, parallel continuous channels extending in extrusion direction are formed.

The contacting with the at least one protic solvent is preferably carried out at a temperature in the range of 20 to 80° C., more preferably at a temperature in the range of 20 to 60° C. In particular, the at least one protic polar solvent, in particular the water-based coagulation liquid, is held at a temperature in a range of 20 to 80° C., more preferably at a temperature in the range of 20 to 60° C.

In particular, according to a particular preferred embodiment, for the formation of the hollow fiber membrane according to step b), the coagulation liquid as defined above is injected through the hollow needles into the extruded polymer during extrusion. By this setup, the extruded polymer membrane gets a hollow cylindrical geometry and parallel continuous channels extending in extrusion direction are formed in the extruded polymer. Subsequently, the formed hollow fiber is preferably brought in contact with water as coagulation agent. The parameters of the process, like extrusion speed, temperature, nozzle geometry, type of coagulant, concentrations may have an effect on and thus can be used to control parameters such as the membrane's shape and thickness and thus the performance of the membrane. Hollow fiber membranes can be optionally wound up onto rolls and/or bundled to bundles of hollow fibers.

Subsequently, the hollow fiber membrane is isolated according to step c) without carrying out a step of removal of the additive (A) from the membrane.

In this connection, “without carrying out a step of removal of the additive (A) from the membrane” means, that the hollow fiber membrane formed in the inventive process is not subjected to a particular washing step aiming at the removal of the water-soluble polymer additive (A) from the membrane. In particular, no oxidative post-treatment with for example sodium hypochlorite or the like is being performed.

According to a preferred embodiment, the inventive process also comprises a step of
d) rinsing with a liquid comprising water, preferably at elevated temperatures such as 60° C. Preferably the liquid consists of water.

Step d) may be desired and can be optionally carried out to remove residual components from the membrane such as residual amounts of solvent D). Under the conditions of the rinsing step using water, the additive (A), in particular the polyvinylpyrrolidone (PVP) with a K-value of at least 80 contained therein, is not washed out in a substantial extent.

According to a further preferred embodiment, the inventive process also comprises the step of
e) drying the hollow fiber membrane.

Drying can be carried out by any means known to the person skilled in the art of membranes.

According to a further aspect, the present invention relates to a hollow fiber membrane obtainable by the inventive process as described herein.

The obtained inventive hollow fiber membrane is essentially free from the at least one solvent (D). “Essentially free” within the context of the present invention means that the membrane comprises at most 1% by weight, preferably at most 0.5% by weight and particularly preferably at most 0.1% by weight of the at least one solvent based on the total weight of the hollow fiber membrane.

In a fuel cell humidifier, usually water vapor from the exhaust gas of the fuel cell reaction is used to be provided to the fuel cell membrane. The water vapor permeates through a membrane as selectively as possible to be provided to the polymeric electrolyte membrane.

It has been found with the present invention that the hollow fiber membranes described herein, in particular the membranes according to the present invention, can successfully be used as membrane in a humidifier in a fuel cell, because water vapor can pass through the humidifier membrane while gas contained in the gaseous mixture is withheld. In particular, the hollow fiber membranes have proven to be selectively gas-tight with respect to unwanted gas, such as for example nitrogen and that the membranes are effective at the operation temperatures of a fuel cell which is usually at 80 to 90° C. The hollow fiber membranes described herein have shown to perform particularly well and selectively in this temperature range.

According to a further aspect, the present invention thus relates to a separation element, a membrane module, a membrane cartridge or a separation system comprising the inventive hollow fiber membrane as described herein.

Still a further object of the present invention is a humidifier comprising the inventive hollow fiber membrane as described herein, in particular a humidifier which is a fuel cell membrane humidifier.

Still a further object of the present invention is a humidifier comprising a hollow fiber membrane, wherein the membrane comprises a porous supporting structure, an inner membrane surface layer (SLᵢₙ) and an outer membrane surface layer (SLₒᵤₜ), and wherein the membrane comprises at least one polymer (P) selected from a sulfonated poly(arylene ether sulfone) and a poly(arylene ether sulfone) and a water-soluble polymer additive (A) comprising polyvinylpyrrolidone (PVP). In particular, the humidifier is a fuel cell membrane humidifier.

In still a further aspect, the present invention relates to a fuel cell comprising a hollow fiber membrane, wherein the membrane comprises a porous supporting structure, an inner membrane surface layer (SLᵢₙ) and an outer membrane surface layer (SLₒᵤₜ), and wherein the membrane comprises at least one polymer (P) selected from a sulfonated poly(arylene ether sulfone) and a poly(arylene ether sulfone) and a water-soluble polymer additive (A) comprising polyvinylpyrrolidone (PVP).

In still a further aspect, the present invention relates to a fuel cell comprising the inventive hollow membrane as described herein.

In still a further aspect, the present invention relates to a fuel cell comprising a separation element, membrane module, membrane cartridge or separation system comprising the inventive hollow fiber membrane as described herein.

In still a further aspect, the present invention relates to a fuel cell comprising a humidifier, in particular a fuel cell membrane humidifier, wherein said humidifier comprises a hollow fiber membrane, wherein the membrane comprises a porous supporting structure, an inner membrane surface layer (SLᵢₙ) and an outer membrane surface layer (SLₒᵤₜ), and wherein the membrane comprises at least one poly(arylene ether sulfone) polymer (P) and a water-soluble polymer additive (A) comprising polyvinylpyrrolidone (PVP).

In still a further aspect, the present invention relates to a fuel cell comprising an inventive humidifier, in particular a fuel cell membrane humidifier as described herein.

### EXAMPLES

Abbreviations and compounds used in the examples:
NTU nephelometric turbidity unit
WTR water transmission rate
NMP N-methyl-2-pyrrolidone [CAS 872-50-4]
PVP Polyvinylpyrrolidone
BET Brunauer-Emmet-Teller surface assessment
PAES Poly(arylene ether sulfone) used in the examples:
   Ultrason® E 6020 P: Polyethersulfone with a viscosity number (measured based on ISO 1628-5 (1998) in a 1 wt.-% polymer solution in N-methylpyrrolidone) of 81 ml/g; a glass transition temperature (DSC, 10 K/min; according to ISO 11357-1 (2017) and 11357-2 (2020)) of 225° C.; a molecular weight M_{w} (GPC in THF, PS standard) of 75000 g/mol, and M_{w}/Mₙ=3.4
Luvitec® K90 Polyvinylpyrrolidone with a solution viscosity characterized by the K-value of 90, determined according to the method of Fikentscher (Fikentscher, Cellulosechemie 13, 1932 (58))

### Turbidity

The polymer solution turbidity was measured with a turbidimeter 2100AN (Hach Lange GmbH, Düsseldorf, Germany) employing a filter of 860 nm at 60° C. and expressed in nephelometric turbidity units (NTU). NTU values below 1 are preferred.

### WTR Rate, Nitrogen Permeability

The water vapor transmission rate (WTR, g/s m²) was tested on mini modules comprising 8 to 10 hollow fibers of 10 cm length. Also, the nitrogen permeability (L/m² h bar) at a pressure of 2 bar was assessed before and after WTR measurements at 80 and 90° C. A high WTR in combination with low nitrogen leakage is desired.

### Viscosity

The polymer solution viscosity was measured with a Brookfield Viscometer DV-I Prime (Brookfield Engineering Laboratories, Inc. Middleboro, USA) with RV 6 spindle at 60° C. with 20 rpm.

### PVP Content

The polyvinylpyrrolidone (PVP) content of the membranes (PVPₜₒₜₐₗ) was determined by dissolving the membrane sample in N,N-dimethylformamide (DMF) and casting the solution as film on KRS-5 windows of thalliumbromiodide. The films were dried at 160° C. and analyzed with a Nicolet 6700 FT-IR spectrometer (Thermo Fischer Scientific, Waltham, Massachusetts, USA). Together with calibration samples of known polyvinylpyrrolidone content, the adsorption band at 1680 cm-1 was used to determine the overall polyvinylpyrrolidone content of the membrane samples. The polyvinylpyrrolidone content of the inner membrane surface layer and outer membrane surface layer (PVPᵢₙ, PVPₒᵤₜ) was estimated with the same adsorption band by attenuated infrared spectroscopy (ATR) and reference samples.

### BET Surface Assessment

Solvent exchanged and dried membrane samples were used for Brunauer-Emmet-Teller (BET) surface assessment. The wet membrane samples were stored for 12 h subsequently in water/ethanol (1:1 wt/wt), water/ethanol (1:2 wt/wt), ethanol/n-hexane (1:1 wt/wt) and finally n-hexane before drying at 60° C. under vacuum. The BET surface was determined by gas-adsorption-desorption (GAD) experiments with nitrogen by 5-point method with ASAP 2420 (Fa. Micromeritics, Norcross, USA). The samples were activated at 130° C. for 15 min before measurement.

### Preparation of Hollow Fiber Membranes

### General Procedure

The amounts given in this general procedure are general ranges, the exact amount for the respective experiment can be found in table 1. A clear viscous solution containing 19 wt % membrane polymer and 5 wt % polyvinylpyrrolidone in 76 wt % NMP was prepared using a SpeedMixer® DAC 600.1 Vac-P (Hauschild & Co. KG, Hamm, Germany) at speeds of 200, 800 and 1200 rpm within 30 minutes of mixing. The solution was degassed overnight at room temperature. A center fluid was prepared by mixing distilled water and N-Methylpyrrolidone (NMP). The weight fraction of the two components in the center fluid was: water:NMP=60 wt %:40 wt %.

A hollow fiber membrane was formed by reheating the polymer solution at 60° C. for 2 hours and passing the solution as well as the center fluid through a spinning die. The diameter of the spinning die was 0.33 mm-0.62 mm-1.3 mm. The temperature of the die was 60° C. The hollow fiber was formed at a spinning speed of 13 cm/min. The polymer solution leaving the die with 3.0 ml/min while the center fluid was leaving the die with 3.3 ml/min. The liquid capillary was passed into a water bath having a temperature of 24° C. The distance between the die and the precipitation bath was 13 cm. The hollow fiber membrane formed was guided through one water bath and subsequently was wound onto a winding reel. Afterwards the membrane was directly dried (treatment A) or treated with 2000 ppm aqueous sodiumhypochlorite (NaOCl) at pH 9.5 for 3 hours and 20 hours water extraction at 80° C. with subsequent drying (post treatment B).

TABLE 1
Composition and properties of humidifier membranes
prepared from a blend of PAES and PVP (PVP K90).

| | poly(arylene | | | | |
|---|---|---|---|---|---|
| | ether | | | | |
| | sulfone) | | | | |
| | polymer | | | | |
| | (P) | | | Viscosity | Turbidity |
| | E 6020P | K90 | NMP | @60° C. | @60° C. |
| membrane | [wt %] | [wt %] | [wt %] | [Pas*s] | [NTU] |
| M-2 | 19 | 6 | 76 | 17300 | 0.40 |

TABLE 2
Properties of humidifier membranes prepared from a blend of
PAES and PVP (PVP K90); with treatment A or B (=post treatment);
PVP contents according to infrared (IR) analysis and fiber
dimensions according to scanning electron microscopy (SEM).

| | | Outer- | Inner- | Wall | PVPₒᵤₜ | PVPᵢₙ | PVPₜₒₜₐₗ |
|---|---|---|---|---|---|---|---|
| membrane | treatment | ø [μm] | ø [μm] | [μm] | [wt %] | [wt %] | [wt %] |
| M-2 | A (M-2A) | 827 | 643 | 90 | 16 | 15.6 | 16.4 |
| M-2 | B (M-2B) | 827 | 643 | 90 | 2.0 | 1.2 | 4.0 |

TABLE 3
Properties of humidifier membranes prepared from a blend of
PAES and PVP (K90); nitrogen permeability at 2 bar pressure.

| | Nitrogen | Nitrogen | BET |
|---|---|---|---|
| | leakage before | leakage after | surface |
| membrane | WTR [L/m² h bar] | WTR [L/m² h bar] | [m²/g] |
| M-2A | 2.06 | 6.91 | 27.39 |
| M-2B | 5139.02 | 4506.23 | 37.90 |

TABLE 4
Properties of humidifier membranes prepared from a blend
of PAES and PVP (K90); water transmission rate (WTR, kg/h
m²) at 80° C. at a given water flux (WET-IN, g/s m²).

| water flux [g/s m²] | M-2A [kg/h m²] | M-2B [kg/h m²] |
|---|---|---|
| 1.493049 | 1.779 | |
| 1.55958 | | 2.519 |
| 1.826551 | | |
| 3.127856 | | 3.877 |
| 3.139537 | 2.852 | |
| 3.658199 | | |
| 4.634059 | 3.322 | |
| 4.683813 | | 4.701 |
| 5.480577 | | |
| 6.159916 | 3.611 | |
| 6.276971 | | 5.291 |
| 7.306704 | | |
| 7.695394 | 3.795 | |
| 7.822357 | | 5.719 |
| 9.133948 | | |
| 9.181977 | 3.874 | |
| 9.376417 | | 6.047 |
| 10.77913 | 4.003 | |
| 10.93795 | | |
| 10.95882 | | 6.318 |
| 12.31646 | 4.062 | |
| 12.50396 | | 6.542 |
| 12.78243 | | |
| 14.57658 | | |

TABLE 5
Properties of humidifier membranes prepared from a blend
of PAES and PVP (K90); water transmission rate (WTR, kg/h
m²) at 90° C. at a given water flux (WET-IN, g/s m²).

| water flux [g/s m²] | WTR M-2A [kg/h m²] | WTR M-2B [kg/h m²] |
|---|---|---|
| 3.513228 | 3.375 | |
| 3.56656 | | 4.49 |
| 4.182543695 | | |
| 7.035047 | 4.898 | |
| 7.134506 | | 6.697 |
| 8.358423845 | | |
| 10.54664 | 5.589 | |
| 10.70696 | | 7.929 |
| 12.53755618 | | |
| 14.01766 | 5.941 | . |
| 14.26754 | | 8.76 |
| 16.71117041 | | |
| 17.56252 | 6.156 | |
| 17.86007 | | 9.363 |
| 20.84803683 | | |
| 21.25705 | 6.332 | |
| 21.53643 | | 9.851 |
| 24.56534 | 6.332 | |
| 24.81422597 | | |
| 25.01532 | | 10.216 |
| 28.13045 | 6.376 | |
| 28.55632 | | 10.502 |
| 28.66011236 | | |
| 32.38543383 | | |

The hollow fiber membranes according to the invention show a particularly low gas leakage of <10 L/m² h bar (table 3), and, at the same time, have high water transmission rates (WTR rates) at temperatures of 80 and 90° C. at all relevant water flux values (tables 4 and 5). In contrast, the post treated open porous hollow fiber M-2B shows higher WTR rates but significantly higher nitrogen leakage, which makes it useless for fuel cell membrane humidifiers.

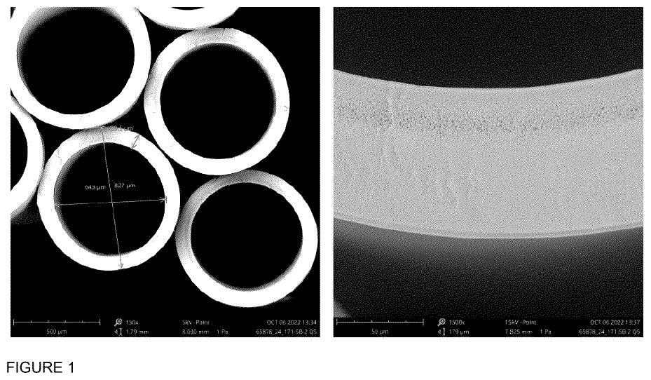

FIG. 1 Secondary electron microscopy of M-2A (150× and 1500× magnification).

1.-17. (canceled)

18. A fuel cell membrane humidifier comprising a hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP).

19. A method for selectively withholding nitrogen gas and selectively letting through water vapor from a gaseous mixture comprising water vapor and nitrogen, the method comprising employing a hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP).

20. A hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising at least 10% by weight, based on the total weight of the membrane, polyvinylpyrrolidone (PVP) having a solution viscosity characterized by a K-value of at least 80.

21. The membrane of claim 20, wherein the content of the polyvinylpyrrolidone in the inner or outer membrane surface layer is at least 10% by weight based on the total weight of the membrane.

22. The membrane of claim 20, wherein at least one of the inner or outer membrane surface layer has a water vapor transmission rate of at least 3.5 kg/h·m² at 80° C. at a water flux of 10 g/s m².

23. The membrane of claim 20, wherein at least one of the inner or outer membrane surface layer has a nitrogen gas permeability of 3 L/m²·h·bar or lower at 2 bar.

24. The membrane of claim 20, wherein the BET (Brunauer-Emmet-Teller) value of the hollow fiber membrane is 30 m²/g or less.

25. The membrane of claim 20, wherein the at least one polymer (P) does not contain any sulfonated poly(arylene ether sulfone).

26. A method for the preparation of a hollow fiber membrane according to claim 20 comprising the steps:
a) providing a solution (S) which comprises at least one polymer (P) selected from a sulfonated poly(arylene ether sulfone) and a poly(arylene ether sulfone), a water-soluble polymer additive (A) comprising polyvinylpyrrolidone (PVP) having a solution viscosity characterized by a K-value of at least 80, and at least one solvent (D);
b) passing the solution (S) through a spinneret and contacting the hollow fiber formed with at least one protic polar solvent, thereby forming the hollow fiber membrane; and
c) isolating the hollow fiber membrane without carrying out a step of removal of the additive (A) from the membrane.

27. The method of claim 26, wherein the solution (S) comprises at least 3% by weight of the polyvinylpyrrolidone (PVP) with a solution viscosity characterized by a K-value of at least 80.

28. A hollow fiber membrane obtained by the process of claim 26.

29. A separation element, a membrane module, a membrane cartridge or a separation system comprising the hollow fiber membrane according to claim 20.

30. A humidifier comprising a hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP), or the hollow fiber membrane according to claim 20.

31. The humidifier of claim 30, which is a fuel cell membrane humidifier.

32. A fuel cell comprising a hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP), the hollow fiber membrane according to claim 20, the separation element, membrane module, a separation element, a membrane module, a membrane cartridge or a separation system comprising the hollow fiber membrane according to claim 20, or a humidifier comprising a hollow fiber membrane comprising a porous supporting structure, an inner membrane surface layer (SLᵢₙ) and an outer membrane surface layer (SLₒᵤₜ), the membrane comprising at least one polymer (P) selected from a sulfonated poly(arylene ether sulfone) and a poly(arylene ether sulfone), and a water-soluble polymer additive (A) comprising polyvinylpyrrolidone (PVP), or the hollow fiber membrane according to claim 20.

33. A fuel cell membrane humidifier comprising the hollow fiber membrane according to claim 20.

34. A method for selectively withholding nitrogen gas and selectively letting through water vapor from a gaseous mixture comprising water vapor and nitrogen, the method comprising employing a hollow fiber membrane according to claim 20.
